(19) United States
(12) Patent Application Publication
(10) Pub. No.: US 2022/0113818 A1
(43) Pub. Date: Apr. 14, 2022

(54) Input Device Docking

(71) Applicant: Hewlett-Packard Development Company, L.P., Spring, TX (US)

(72) Inventors: Ching-Ming Wang, Taipei City (TW); Hui-Jen Tseng, Taipei City (TW)

(73) Assignee: Hewlett-Packard Development Company, L.P., Spring, TX (US)

(21) Appl. No.: 17/298,563

(22) PCT Filed: Jul. 1, 2019
(86) PCT No.: PCT/US2019/040142

§ 371 Date: May 29, 2021

(51) Int. Cl. G06F 3/0354; G06F 1/16

(52) U.S. Cl. CPC G06F 3/03547; G06F 1/1616; G06F 1/165; G06F 1/169

(57) ABSTRACT

An electronic input device may function interchangeably as a trackpad in a first position and a display in a second position. A housing of the input device may facilitate selective docking of the input device surface in first and second positions. In a first position, the input device may, for example, be docked on the base of a laptop computer to operate in a trackpad mode. In a second position, the input device may, for example, be docked on an exterior portion of a closed display lid of the laptop computer to operate in a display mode to display notifications from the laptop computer.

### BACKGROUND

Devices, such as a laptop, may include a touchpad to allow a user to control a mouse and/or navigate a screen of the device. At times, the device may enter a low-power state, such as sleep mode. While the device is in a low-power state, the device may still receive and/or send notifications. However, these notifications may not be viewed without removing the device from its low-power state.

### BRIEF DESCRIPTION OF THE DRAWINGS

Non-limiting and non-exhaustive examples of the disclosure are described, including various examples of the disclosure, with reference to the figures, in which:

FIG. 1 illustrates a perspective view of an example laptop computing device comprising a base, a display, and a removable input device.

FIG. 2 illustrates a perspective view of an example laptop computing device in an open position comprising a base, a display, and an input device.

FIG. 3 illustrates a perspective view of an example laptop computing device in a closed position comprising a base, a display enclosure, and an input device.

FIG. 4 illustrates a perspective view of an example system comprising a laptop computing device in a closed position comprising a base, a display enclosure, and an input device, wherein the input device is in a removed from and remotely connected to the laptop computing device.

FIG. 5 illustrates a perspective view of an example system comprising a laptop computing device in a partially open position, wherein the input device is coupled to a wristband to operate in a smartwatch mode.

FIG. 6 illustrates an example of a computing system that includes a processor, a memory, a communication interface, and a computer-readable storage medium.

### DETAILED DESCRIPTION

Some computing devices allow for operation in low-power states (e.g., sleep mode, hibernation mode, reduced-power mode, etc.) that allow devices to retain some reduced functionality while conserving power. For example, a device might enter a power saving state when the device has not been used for a preset amount of time. The device may shut down and/or disable some elements of the device in the power saving state. For example, a laptop computer may be configured such that if there are no keystrokes, mouse-pointer movement, or other user input for 30 minutes, the screen may shut off. In other examples, the device may enter a low-power state, such as sleep mode, after a preset amount of time or in response to a user selection or action (e.g., closing the display enclosure of the laptop).

Once the device enters a power saving state, some components of the device may be inactive or disabled. A disabled component, such as trackpad, pointer controller, keyboard, screen, etc., may limit user access and/or control of the device. For example, notifications may not be viewable on a laptop's main display when the device is in a low-power state. Similarly, user input controls via traditional inputs, such as a keyboard or mouse, may not be possible while the laptop is in a low-power state.

An input device, as described herein, may be selectively coupled to different dock couplers on a computing device to perform different, location-based functions. The input device may, for example, provide some limited display and/or input functionality for the computing device while the computing device is in a low-power state. For example, the input device may be coupled to a dock coupler on an exterior surface of a display enclosure of a computing device, such as a laptop. The input device may operate in a display mode while coupled to the exterior surface of the display enclosure and, for example, allow a user to review notifications while the computing device remains in a low-power state with the display enclosure of the computing device in a closed position (e.g., the “lid” of a laptop may be closed).

When the display enclosure is opened, the main display of the computing device enclosed by the display enclosure may become active. The input device may be removed from the exterior surface of the display enclosure and coupled to a dock coupler in a trackpad location of the computing device to operate in a trackpad mode. A touch-sensitive surface of the input device may receive touch inputs to, for example, control a mouse pointer in an operating system of the computing device.

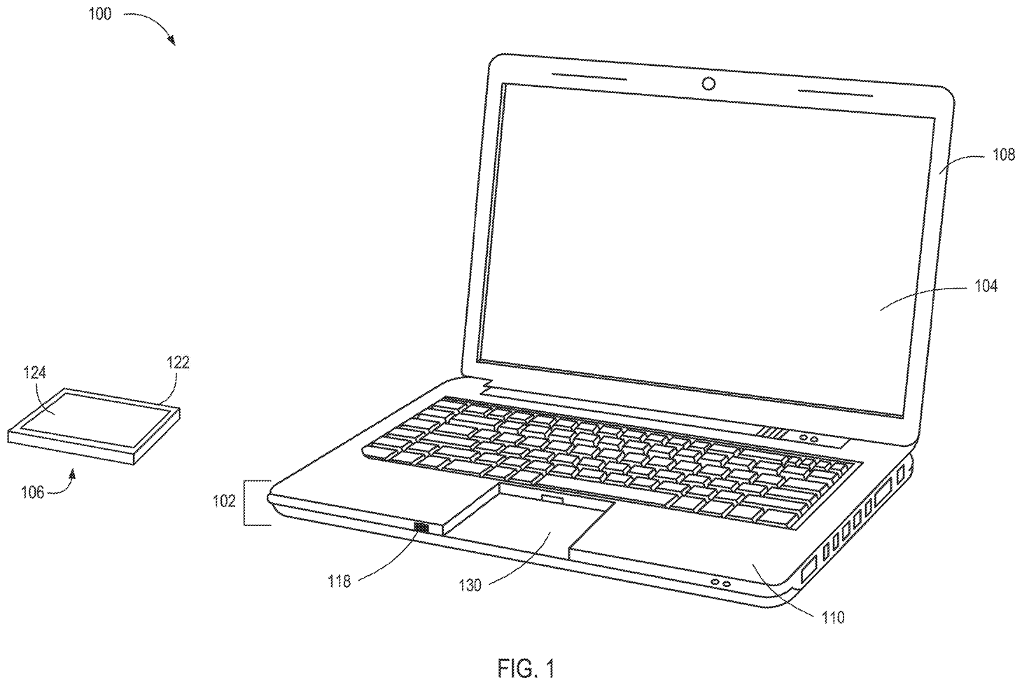

FIG. 1 illustrates a perspective view of an example laptop computing device 100 comprising a base 102, a display 104, and an input device 106. In some examples, the input device 106 may be a touchscreen device, where the display and the touch-sensitive surface are on the same surface of the input device. In alternative examples, the input device 106 may be two-sided with one surface having a display and an opposing surface having a touch-sensitive trackpad surface.

The base 102 of the computing device houses a processor and a memory and includes a trackpad docking location with a dock coupler 130 within which the input device 106 can be coupled. The dock coupler 130 may comprise any combination of mechanical, adhesive, and/or magnetic components to selectively retain the input device 106. In the illustrated example, the dock coupler 130 is positioned within a cavity in the base 102 such that the input surface 106 can be coplanar with an upper surface of the base 102. A display enclosure 108 is pivotally attached to a base enclosure 110 to selectively position the display 104 of the laptop computer 100 between a closed position and a fully open position, relative to the base 102. The input device 106 may include an input display surface 124 and a housing 122 to secure the input device surface 124.

The input device 106 can be selectively docked in the dock coupler 130 in the trackpad docking location. In some examples, as described herein, the input device 106 can be selectively removed from the dock coupler 130 (as illustrated) and coupled to a second dock coupler in a display docking location on an exterior surface of the display enclosure 108. In some examples, the dock coupler 130 may be a magnetic dock coupler to magnetically couple the input device 106 in the trackpad docking location. In some examples, the dock coupler 130 may be a mechanical dock coupler to mechanically couple the input device 106 in the trackpad docking location.

In some examples, a key 118 may be utilized to selectively lock and unlock the input device 106 from the base 102. For example, with the key 118 removed, the input device 106 may be locked in the trackpad docking location. Inserting the key 118 may allow the input device 106 to be selectively removed from the trackpad docking location. In some examples, the key 118 may be utilized to unlock the input device 106 from the dock coupler 130, allowing the input device 106 to be removed. The key 118 may be a physical key, a virtual key, a switch, an electronic key, or a combination thereof. The key 118 may be further utilized to ensure the input device 106 remains in the first location.

The input device 106 may automatically operate in a trackpad mode while in the dock coupler 130 in the trackpad docking location. In some examples, the computing device 100 may control the input device 106. The computing device 100 may detect that the input device 106 is in the trackpad docking location and cause the input device 106 to operate in the trackpad mode. In some examples, a controller within the input device 106 may detect the location in which the input device is docked and automatically enter the trackpad mode.

In trackpad mode, the input device 106 may receive touch inputs (e.g., gestures, swipes, button clicks, multi-touch gestures) from a user. The touch inputs may be translated by the input device 106 and/or the computing device 100 to, for example, operate a mouse pointer, navigate a graphical user interface, and/or otherwise control the computing device 100. In some examples, the input device 106 may be connected to the computing device 100 by a power and/or a communication connector or cable, such as a ribbon cable. In some examples, the connector may be removable and/or retractable.

In some examples, the input device may be in wireless communication with a wireless communication module of the laptop computing device 100 to display notifications for the laptop computing device 100. The input device 106 may further include a battery. The battery may power the input device 106 when the input device 106 is disconnected from the computing device 100. In some examples, the computing device 100 may charge the battery while the input device 106 is coupled to the dock coupler 130.

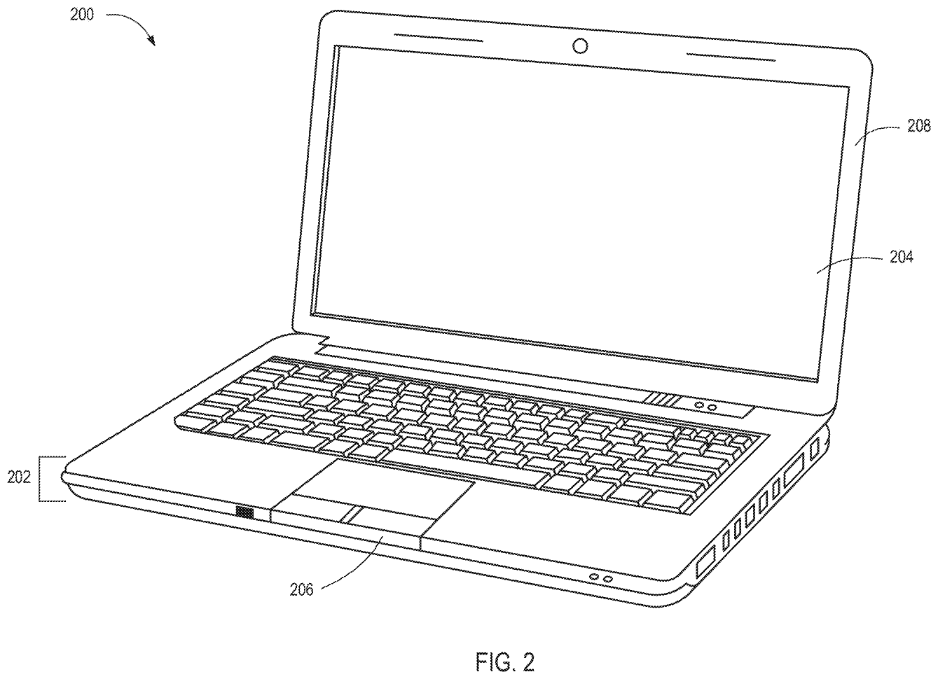

FIG. 2 illustrates a perspective view of an example laptop computing device 200 in an open position comprising a base 202, a display 204, and an input device 206. The input device 206 is shown coupled in a trackpad docking location of the laptop computing device 200. In the trackpad docking location, the input device 206 may operate in a trackpad mode. Display functionality of the input device 206 may be leveraged to display virtual buttons in locations on the input device 206 where button click inputs may be made by a user.

In some examples, the input device 206 is magnetically docked to the base 202 of the laptop computing device 200. In some examples, a housing facilitates mechanical coupling of the input device surface. In some examples, the input device 206 is docked in the first location via a hook or other fastener integrated into the input device 206 and/or the exterior of the display enclosure 208. In some examples, a cable to connect the input device 206 to the base 202 of the laptop may be retracted while the input device 206 is in the trackpad docking location. For example, the retracted cable may be housed in the base 202 of the laptop computing device 200.

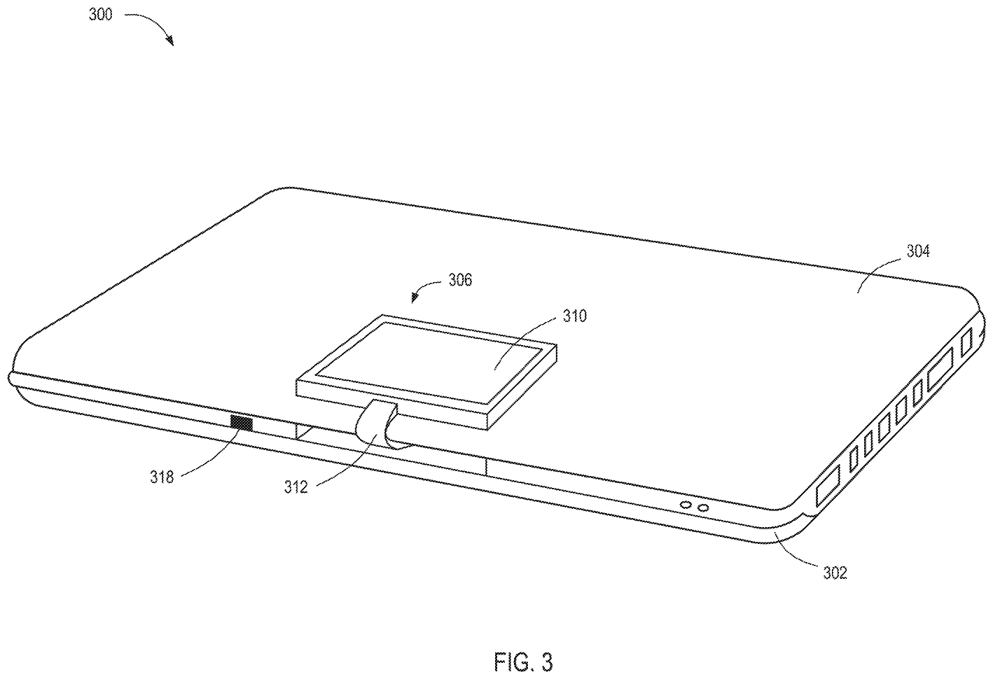

FIG. 3 illustrates a perspective view of an example laptop computing device 300 in a closed position comprising a base 302, a display enclosure 304, and an input device 306 coupled to a dock coupler in a display docking location on an exterior of the display enclosure 304. In some examples, the input device 306 may be magnetically or mechanically coupled in the display docking location. In some examples, the input device 306 may be coupled in the display docking location via a hook, fastener, adhesive, magnetic connection, mechanical latch, or the like that may be integrated into the input device 306 and/or the exterior of the display enclosure 304. A key 318 may be utilized to unlock and/or lock the input device 306. In some examples, a physical key is used to unlock the input device 306 from the dock connector in the trackpad docking location shown in FIGS. 1 and 2. Once unlocked, the input device may be coupled to the dock coupler in the display docking location, as shown in FIG. 3.

In some examples, the key 318 may also be used to lock and unlock the input device 306 from the display docking location. In some examples, a touchscreen 310 of the input device 306 is connected to the laptop computing device 300 via a cable 312 extending from the base 302 and around the edge of the display enclosure 304. In some examples, the cable 312 may allow for delivery of power and/or provide a communication channel between the laptop computing device 300 and the input device 306. The cable 312 may expand and retract to accommodate the changing distance between the laptop computing device 300 and the input device 306.

The input device 306 may operate in the display mode when in the display docking location. In display mode, the input device 306 may be utilized as a display screen of the laptop computing device 300. With the display enclosure 304 closed, the laptop computing device 300 may enter a sleep mode, a hibernation mode, or another low-power state while the input device 306 is in the second position. The input device 306 may be utilized in display mode and/or trackpad mode while the computing device 300 is in a low-power state. The computing device 300 may remain in the low-power state while a user utilizes the input device 306 to review a notification, view display elements, and/or provide touch inputs. In some examples, the input device 306 may include motion detectors, speakers, microphones, and/or other input/output devices.

As an example, the laptop computing device 300 may remain in a low-power state with the display enclosure 304 closed while playing music. The user may utilize the input device 306 to view song information and select a new song. As another example, the user may review received emails and other messages via the input device 306 while the laptop computer remains closed and in the low-power state.

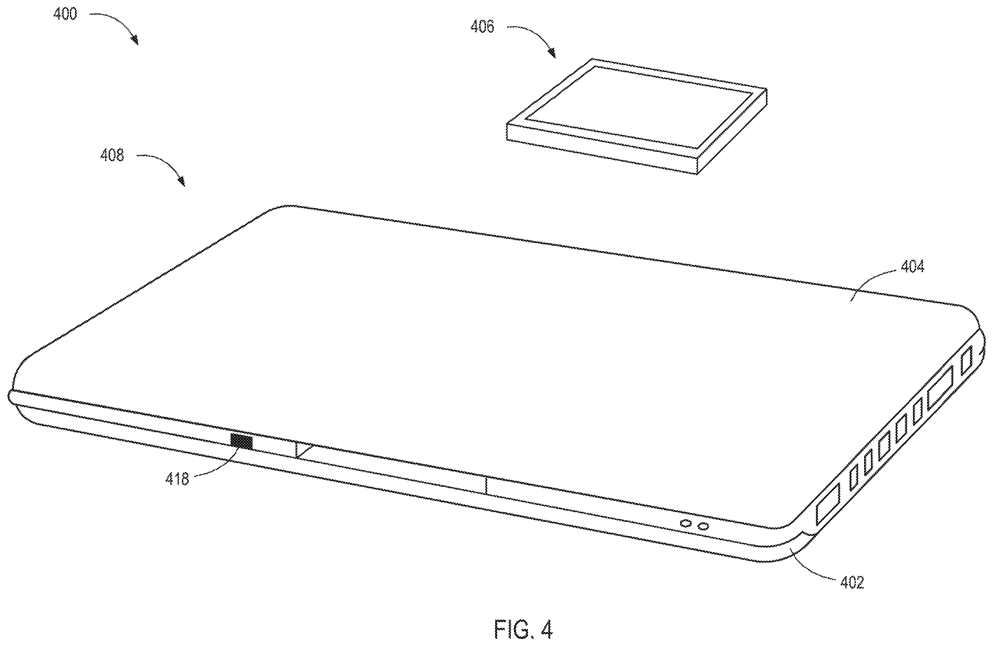

FIG. 4 illustrates a perspective view of an example system 400 comprising a laptop computing device 408 in a closed position. The laptop computing device 408 includes a base 402, a display enclosure 404, and a removable input device 406. The removable input device 406 is shown removed to a remote location. The remote location may be a remote docking location with a third dock coupler. The input device 406 may remain in wireless communication with the laptop computing device 408 even when the input device 406 is removed from the laptop computing device 408. Removing the input device 406 from the trackpad docking location may activate display mode. The input device 406 may operate in display mode to display notifications and elements of the computing device 408 and/or operate in trackpad mode to control media playback and input to control elements of the computing device 408. The input device 406 may perform these functions while the computing device 408 is and remains in a low-power state. The input device 506 may be utilized without causing the computing device 408 to change physical state and/or low-power state.

The laptop computing device 408 and the input device 406 may remain connected via any of a wide variety of wireless communication protocols and hardware configurations, such as WiFi or Bluetooth. The input device 406 may include a controller or processor, memory, and a wireless communication module secured within a housing.

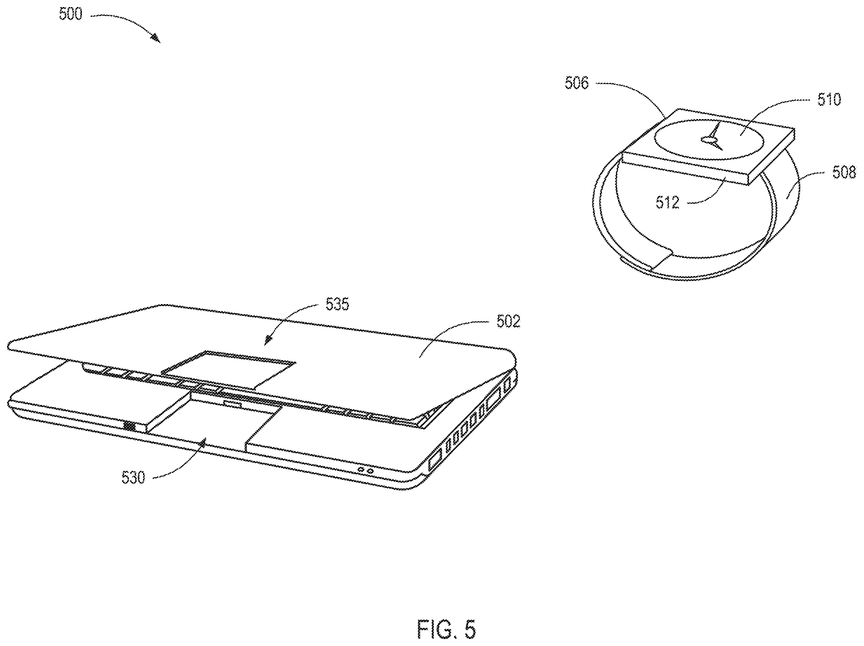

FIG. 5 illustrates a perspective view of an example system 500 comprising a laptop computing device 502 in a partially closed position and an input device 506 in a third dock coupler in a wristband docking location of a wristband 508. The wristband 508 facilitates securing the input device 506 to a wrist of a user. The input device 506 may be in a housing 512 to facilitate coupling of the input device 506 to the wristband 508.

The input device may, as in other examples, be a touchscreen device that operates in a trackpad mode when coupled to a first dock connector in the trackpad docking location 530. The input device 506 may operate in a display mode when coupled to a second dock connector in the display docking location 535 on the exterior surface of the display enclosure of the laptop computing device 502. The input device 506 may operate in a smartwatch mode (e.g., to display a clock 510) when coupled to a third dock connector in a wristband docking location of a wristband 508. The input device 506 may, for example, be magnetically or mechanically docked to the wristband 508.

Utilizing the input device 506 in the wristband 508 allows a user to receive notifications, control the computing device 502, and/or use components of the computing device 502 while moving about a room or other area. For example, a user may place the input device 506 in the wristband 508 and then leave the computing device 502 to work on a project across the room. While across the room, the user may listen to music, receive emails, and/or utilize other components of the computing device 502 via the input device 506 docked in the wristband 508. In some examples, the input device 506 may communicate with the computing device 502 via a wide area network or cloud computing resources. In such examples, the input device 506 may remain in communication with the computing device in remote locations. The input device 506 may be coupled to dock couplers in any of a wide variety of alternative locations in which it may be useful to have a remote display and/or touch input surface for the laptop computing device 502. Examples of such locations include, but are not limited to, other structures, walls, furniture, or other articles of clothing.

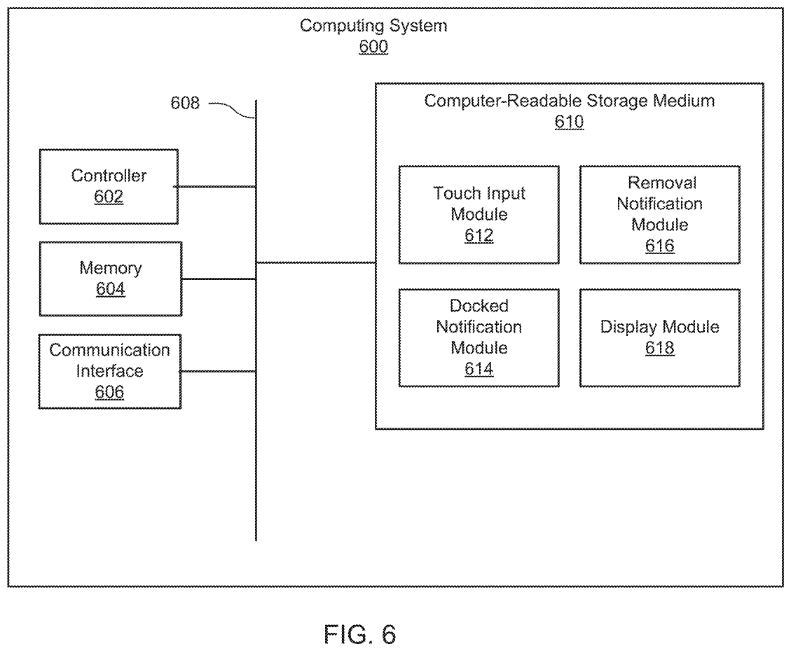

FIG. 6 illustrates an example of a computing system 600 that includes a bus 608 connecting a controller 602 (e.g., microprocessor, Field Programmable Gate Array (FPGA), microcontroller, etc.), a memory 604, a communication interface 606, and a computer-readable storage medium 610. The computer-readable storage medium 610 may include various modules 612-622. In the illustrated example, the modules 612-624 are implemented as instructions to be executed by the controller 602. However, in other examples, one or more of the modules 612-622 may be implemented as processor executable instructions, firmware, hardware, or combinations thereof.

A touch input module 612 may receive touch inputs from the touchscreen of an input device in a trackpad mode to, for example, control a pointer in an operating system of the computing device. Touch inputs may be provided by a user via a finger or stylus. A docked notification module 614 may determine or detect in which docking location the touchscreen device is docked. An operational mode of the input device may be selected based on the identified docking location. A removal notification module 616 may detect the removal of the input device from a docking location on the computing device. Detecting the removal of the input device may initiate a change in the operational mode of the input device. For example, if the input device is in the trackpad docking location, the input device may operate in the trackpad mode. Once removal is detected, the input device may transition to a display mode and disable further input via the input device. In other examples, the input device may transition to a display mode but still allow some inputs via the input device. Such a mode may be referred to as a display mode or as a dual trackpad-display mode.

A display module 618 renders a notification associated with the computing device for display by the input device in the display mode when, for example, the input device is in a display docking location on an exterior surface of a display enclosure. The display module 618 may render notification(s) and/or element(s) of the computing device for display by the input device in display mode while the input device is in remote docking locations, such as in a wristband docking location.

While many examples herein focus on computing devices, such as laptops, other devices such as three-dimensional printers, medical devices, and/or other electronic devices may be adapted to utilize an input device as described herein.

What is claimed is:

1. A computing device, comprising:
a base enclosure to house a processor and memory;
an input device;
a first dock coupler to couple the input device to the base enclosure;
a display enclosure pivotably attached to the base enclosure to position a display of the computing device between a closed position and a fully open position, relative to the base enclosure;
a second dock coupler to couple the input device to an exterior surface of the display enclosure, wherein the input device is to:
operate in a trackpad mode when the input device is coupled to the first dock coupler and the display enclosure in an open position, and
operate in a display mode when the input device is coupled to the second dock coupler and the display enclosure in the closed position.

2. The laptop computing device of claim 1, wherein each of the first dock coupler and the second dock coupler comprises a magnetic dock coupler to magnetically couple the input device.

3. The laptop computing device of claim 1, wherein the input device is in wireless communication with a wireless communication module of the laptop computing device to display notifications from the laptop computing device while the input device is in the second dock coupler with the display enclosure in the closed position.

4. The laptop computing device of claim 1, wherein the input device is connected to the computing device via a cable extending from the base of the laptop computer and around an edge of the display of the laptop computer.

5. The laptop computing device of claim 4, wherein the first dock coupler comprises a mechanical coupler to mechanically couple the input device thereto, and wherein the second dock coupler comprises a magnetic dock coupler to magnetically couple the input device thereto.

6. The laptop computing device of claim 4, wherein the input device is docked in the second dock coupler via a hook integrated into the input device, the exterior of the display enclosure, or a combination thereof.

7. A computing device, comprising:
a display portion;
a base; and
an input device including:
a touchscreen;
a housing to enclose the touchscreen;
a connector on the housing to selectively connect the touchscreen:
to a first dock receiver on the base in which the touchscreen is to operate in a trackpad mode with a display portion of the computing device open, and
to a second dock receiver on an exterior of the display portion in which the touchscreen is to operate in a display mode with the display portion of the computing device closed.

8. The computing device of claim 7, further comprising a key to selectively lock and unlock the touchscreen from the first dock receiver or the second dock receiver.

9. The electronic device of claim 7, wherein the touchscreen is connected to the computing device via a ribbon cable extending from the base of the computing device and around an edge of the display portion of the computing device.

10. The computing device of claim 7, further comprising:
a controller in communication with the touchscreen;
a memory in communication with the controller; and
a wireless communication module in communication with the controller to facilitate wireless communication with the computing device,
wherein the controller, the memory, and the wireless communication module are secured within the housing.

11. The computing device of claim 10, wherein the connector on the housing is further to be selectively connected to a third receiver remote from the computing device.

12. The computing device of claim 11, wherein the third receiver is part of a wristband to facilitate securing the touchscreen to a wrist of a user where the touchscreen is to operate in a smartwatch mode.

13. A non-transitory computer-readable medium with instructions stored thereon that, when executed, cause a processor of a computing device, to:
detect a touchscreen device in a first docked location on a base enclosure of a computing device;
receive touch inputs from the touchscreen device in a trackpad mode to control a pointer in an operating system of the computing device;
detect the removal of the touchscreen device from the first docked location on the computing device;
detect the touchscreen device in a second docked location on an exterior surface of a display enclosure of the computing device with the display enclosure in a closed position relative to the base enclosure; and
rendering a notification associated with the computing device for display by the touchscreen device in a display mode in the second docked location.

14. The non-transitory computer-readable medium of claim 13, wherein the instructions, when executed, further cause the processor to:
receive touch inputs from the touchscreen device in a dual trackpad-display mode with the touchscreen device in the second docked location on the exterior surface of the display enclosure.

15. The non-transitory computer-readable medium of claim 13, wherein the instructions, when executed, further cause the processor to:
render a notification associated with the computing device for display by the touchscreen device in a dual trackpad-display mode with the touchscreen device in the first docked location on the base enclosure.
